(19) United States
(12) Patent Application Publication
(10) Pub. No.: US 2020/0231772 A1
(43) Pub. Date: Jul. 23, 2020

(54) BIAXIALLY ORIENTED, UV-STABILIZED, SINGLE- OR MULTI-LAYER POLYESTER FILM WITH ANTI-GLARE AND FLAME-RETARDANT COATING ON AT LEAST ONE SIDE AND WITH A TRANSPARENCY OF AT LEAST 93.5 %

(71) Applicant: Mitsubishi Polyester Film GmbH, Wiesbaden (DE)

(72) Inventors: Andreas Bork, Westhofen (DE); Claudia Lohre, Wiesbaden (DE); Yavuz Ünker, Nieder-Olm (DE); Thiemo Herbst, Mainz (DE); Viktor Fischer, Oftersheim (DE); Stephan Audörsch, Darmstadt (DE)

(73) Assignee: Mitsubishi Polyester Film GmbH

(21) Appl. No.: 16/744,605

(22) Filed: Jan. 16, 2020

(30) Foreign Application Priority Data
Jan. 18, 2019 (DE) 10 2019 200 626.4

(51) Int. Cl. C08J 7/05; C08J 5/18; C09D 133/08

(52) U.S. Cl. CPC C08J 7/05; C08J 5/18; C08K 5/5333; C08J 2367/02; C08J 2433/08; C09D 133/08

(57) ABSTRACT

A single-layer or multi-layer, biaxially oriented polyester film is provided bearing on at least one film surface a coating for transparency increase. The film has a particle fraction of not more than 0.5% and the coating is a dried water-based or solvent-based solution and/or dispersion having a dry coat thickness of 60-130 nm. The coating includes at least one acrylic acid-based and/or methacrylic acid-based polymer and at least one alkylphosphonate and/or oligo-alkylphosphonate. The coating has a refractive index n<1.64 and a phosphorus fraction of between 2 and 18%. The inventive film is suitable for producing greenhouse energy-saving sheets, particularly for the growing of plants with exacting light demands such as tomatoes. The film has specific transparency properties, high UV stability and good fire properties. The invention further relates to methods for polyester film production and also to the use thereof in greenhouses.

### CROSS-REFERENCE TO RELATED APPLICATIONS

This application claims priority to German Patent Application No. 10 2019 200 626.4 filed Jan. 18, 2019, which is hereby incorporated herein by reference in its entirety.

### FIELD OF THE INVENTION

The present invention relates to a highly transparent, biaxially oriented, UV-stable and flame-stable polyester film furnished on at least one side with a coating which reduces the reflection of visible light and the combustibility. The film of the invention is suitable for producing energy-saving greenhouse sheets. especially for the growing of plants with a high light requirement such as tomatoes, for example. The film has specific transparency properties, high UV stability and good fire properties. The invention furthermore relates to a method for producing the polyester film and to the use thereof in greenhouses.

### BACKGROUND OF THE INVENTION

Films for energy-saving sheets in greenhouses are required to comply with a series of requirements. Firstly, that portion of the light that is required for plant growth is to pass through the film/energy-saving greenhouse sheets, and, in the night and especially in the morning hours, the energy-saving greenhouse sheets are also to keep the heat ascending from the soil in the greenhouse both by retarding convection and by reflecting radiation. Without the energy-saving greenhouse sheet, there is a rise in energy consumption in the greenhouse and it becomes more difficult to establish the ideal climatic conditions. A disadvantage of the sheets generally, however, is the siting of the additional layer in the path of the sun's radiation, this additional layer reducing the amount of light available, both by absorption and by reflection. In the period around midday, the energy-saving sheet can be pulled up, or excessive incidence of light may even necessitate the use of energy-saving sheets for cooling. In the morning hours, however, the energy-saving sheet is of particular significance, since it is here that the temperature needed for plant growth must be attained while at the same time as much light as possible must be made available in order to ensure high photosynthesis activity. In the morning hours in particular, however, the sun is still at a low angle on the horizon, and this leads to even greater reflection at a film surface than when the sun is at a higher position. At the main time of deployment of the sheets in particular, therefore, the reflection must be reduced and the transmission maximized.

The film must, moreover, have a UV stability enabling the deployment of the energy-saving sheet in a greenhouse for at least five years without exhibiting significant yellowing or embrittlement or cracking on the surface or any serious deterioration in the mechanical properties, or suffering any significant loss of transparency.

Greenhouse fires are a substantial source of economic damage, and so the film and the shading mat produced from it must have reduced flammability so that a fire is unable to spread too quickly.

EP3064549 describes a flame-retarded, biaxially oriented polyester film. Particles of aluminium dimethylphosphinate/diethylphosphinate are used for flame retardancy. These particles are located within the extruded polyester layers. The average particle size is quoted for example at 2-3 μm. Experience suggests that particles of such a kind cause film hazing and lower the transparency.

EP1368405 concerns a number of phosphorus-based flame retardants, such as DOPO (CAS 35948-25-5) and derivatives thereof, and their use in biaxially oriented polyester films. The stabilizers described are suitable for production of transparent PET films. The DOPO (CAS 35948-25-5) derivatives described are especially suitable for the PET process, as they can be copolymerized into the PET chain. Even with a film rendered flame-retardant in this way, experience suggests a marked deterioration in flame stability through application of an anti-reflection coating applied to one or both sides.

A layer with flame stabilizer is applied in EP1441001 to an existing polyester film product which has coating on both sides and biaxial orientation, the purpose of the flame stabilizer layer being to stabilize the overall assembly. The flame stabilizer layer comprises a gas-generating compound such as magnesium hydroxide. Magnesium hydroxide is also applied as a flame stabilizer by coating onto a polymer film in EP1527110.

A layer with magnesium hydroxide (or aluminium hydroxide) acts to retard flame only above a certain thickness, and is therefore unsuitable for production procedures which apply a coating in the course of production.

Furthermore, magnesium hydroxide is unsuitable for direct processing with PET in the melt, since the chain length and hence the viscosity of the PET are greatly reduced and can no longer be stably produced.

EP3251841 concerns a biaxially oriented, UV-stabilized, single-layer or multi-layer polyester film with anti-glare coating on at least one side and a transparency of at least 93.5%. The specification describes flame stabilizers for the base film, and suggests that no flame stabilizer is needed if a certain particle concentration is observed. Experience suggests that anti-reflection layers, composed of acrylates, polyurethanes and silicones for instance, on one or both sides of a polyester film have the effect of a drastic deterioration in the fire properties.

The above-described films from the prior art either fail to meet the requirements in terms of optical properties (transparency at least 93.5%; haze not more than 8%) and/or the fire behaviour requirements. Particulate systems usually cause haze in the ultimate laminate and reduce the transparency. The anti-reflection layer or layers applied to the polyester film for reducing reflection are detrimental to the fire properties of the laminate as a whole, especially when the anti-reflection coating is applied to both sides. Flame stabilization solely of the base film, or a low concentration of particles in the base film, is surprisingly unable to provide complete compensation for the adverse effect of an anti-reflection coating applied to one side and especially to both sides.

### SUMMARY OF ADVANTAGEOUS EMBODIMENTS OF THE INVENTION

The problem addressed by the present invention is that of overcoming the disadvantages of the prior art and of providing a film for use as stated above. As well as fulfilling the optical properties such as a transparency of min. 93.5% and a haze of max. 8%, the film is intended to meet the flame stability requirements (i.e. to exhibit reduced flammability as compared with coated, non-flame-stabilized polyester films).

The flame stability is intended to meet the requirements over the entire greenhouse life cycle and not to deteriorate over time.

The problem is solved by a single-layer or multi-layer, biaxially oriented polyester film bearing on at least one film surface a coating for transparency increase, characterized in that:
the polyester film has a particle fraction of not more than 0.5% by weight, and
the coating represents the product of drying of a water-based or solvent-based solution and/or dispersion, where
(i) the coating has a dry coat thickness of 60-130 nm,
(ii) the coating for transparency increase comprises at least one acrylic acid-based and/or methacrylic acid-based polymer and
(iii) comprises as flame stabilizer at least one alkylphosphonate and/or oligo-alkylphosphonate, where
(iv) the coating has a refractive index n<1.64 and
(v) the phosphorus fraction of the coating is between 2 and 18% by weight.

A polyester film of this kind then has the following properties:
a transparency of min. 93.5%,
a haze of max. 8%,
in the fire test, the number of samples which burn up to the retaining ring after the first flame application is less than 3 out of 5 both before and after weathering.

### DETAILED DESCRIPTION OF ADVANTAGEOUS EMBODIMENTS OF THE INVENTION

The polyester film of the invention comprises, or more favourably consists of, polyester (hereinafter also sometimes called base material), additives and at least one coating (hereinafter also called anti-reflection modification or anti-reflection coating). A distinction is made between “layers” and “coating”; a “layer” refers to an extruded or coextruded layer in the polyester film that consists primarily of polyester (e.g. a base layer, intermediate layer or outer layer), whereas a “coating” is applied as a solution or dispersion to one or both surfaces of the (possibly multi-layer) polyester film and is then dried; this may take place “in-line”, in other words within the film production process itself, or “off-line”, in other words after production of the film.

### Base Material

The total film thickness is at least 10 μm and not more than 40 μm. Preferably the film thickness is at least 14 and not more than 23 μm and ideally it is at least 14.5 μm and not more than 20 μm. A film less than 10 μm thick is no longer sufficiently strong mechanically to absorb, without straining, the tensile forces occurring in the energy-saving sheet in application. Above 40 μm, the film becomes too stiff and in the opened, drawn-up state, the resultant “log of film” is too large and its shading correspondingly too great.

The film has a base layer B. Single-layer films consist only of this base layer. In the case of a multi-layer embodiment, the film consists of the (i.e. one) base layer and of at least one further layer, which depending on its positioning in the film is referred to as an intermediate layer (at least in each case one further layer is in that case located on each of the two surfaces) or outer layer (the layer forms an external layer of the film). In the case of the multi-layer version, the thickness of the base layer is at least equal to the sum of the other layer thicknesses. The thickness of the base layer is preferably at least 55% of the total film thickness and ideally at least 63% of the total film thickness. The thickness of the other layers, preferably of the outer layers, is at least 0.5 μm, preferably at least 0.6 μm and ideally at least 0.7 μm. The thickness of the outer layers is not more than 3 μm and preferably not more than 2.5 μm and ideally not more than 1.5 μm. At below 0.5 μm, there are falls in the processing stability and uniformity of thickness of the outer layer. At 0.7 μm upward, processing stability becomes very good. If the outer layers become too thick, cost-effectiveness decreases, since for reasons of ensuring properties (especially the UV stability), regrind (i.e. reprocessed production offcuts/film residues) should be added only to the base, and, if the base-layer thickness is too low in comparison to the total thickness, the percentage of regrind that must be added to this layer in order to complete the regrind circuit is then too large. This may then also have an adverse effect, via the base layer, on the properties such as UV stability and transparency for example. Moreover, the outer layers generally comprise particles for improving the slip properties (improving windability). These particles lead to a loss of transparency through backscatter. If the proportion of the outer layers containing such particles becomes too great, it becomes much more difficult to achieve the transparency properties according to the invention.

High outer layer thicknesses of the film outer layer with anti-glare modification, where present, lead to an unwanted increase in costs, owing to the higher UV stabilizer content of this layer (see below) that is necessary in the case of copolymer-modified layers.

### UV Stabilization

The film is further required to have low transmission in the wavelength range from below 370 nm to 300 nm. At every wavelength within the specified range, transmission is less than 40%, preferably less than 30% and ideally less than 15% (for method see Test Methods). As a result, the film is protected from embrittlement and yellowing, and this also protects the plants and equipment in the greenhouse from UV light. At between 390 and 400 nm the transparency, in one preferred embodiment, is greater than 20%, preferably greater than 30% and ideally greater than 40%, since this wavelength range already exhibits significant photosynthetic activity and excessive filtering in this wavelength range would adversely affect plant growth. The low UV permeability is obtained through the addition of organic UV stabilizer. Low permeability to UV light protects any flame stabilizer present from rapid destruction and severe yellowing. The organic UV stabilizer here is selected from the group of triazines, benzotriazoles or benzoxazinones. Particularly preferred here are triazines, one of the reasons being that they exhibit high thermal stability and low outgassing from the film at the processing temperatures of 275-310° C. that are customary for PET. Especially suitable is 2-(4,6-diphenyl-1,3,5-triazin-2-yl)-5-(hexyl)oxyphenol (TINUVIN® 1577). The most preferred are 2-(2′-hydroxyphenyl)-4,6-bis(4-phenylphenyl)triazines, of the kind sold by BASF under the brand name TINUVIN® 1600, for example. When these are used, the preferred low transparencies below 370 nm can be achieved even with relatively small stabilizer concentrations, and at the same time a greater transparency at wavelengths above 390 nm is achieved.

The film, or at least one outer layer and preferably both outer layers in the case of a multi-layer film, therefore comprises or comprise at least one organic UV stabilizer. UV stabilizers are added to the outer layer/layers or to the monofilm, in one preferred embodiment, in amounts between 0.3 and 3% by weight, based on the weight of the respective layer. Particularly preferred is a UV stabilizer content between 0.75 and 2.8% by weight. The outer layers ideally contain between 1.2 and 2.5% by weight of UV stabilizer. In the multi-layer embodiment of the film, as well as the outer layers, the base layer too preferably comprises a UV stabilizer, in which case the amount of UV stabilizer in % by weight in this base layer is preferably lower than in the outer layer or layers. These stated amounts in the outer layer/layers are based on triazine derivatives. If instead of a triazine derivate a UV stabilizer from the group of the benzotriazoles or benzoxazinones is used completely or partially, then usefully the fraction of the triazine component that is replaced ought to be substituted by 1.5 times the amount of a benzotriazole or benzoxazinone component.

Whitening polymers which at the same time are incompatible with the main polyester constituent, such as polypropylene, cycloolefin copolymers (COCs), polyethylene, non-crosslinked polystyrene, etc., are present for the purposes of the invention at less than 0.1% by weight (based on the weight of the film) and ideally not at all (0% by weight), since they greatly lower the transparency and have a greatly adverse effect on the fire behaviour, and under the effect of UV they exhibit a strong yellowing tendency and would therefore necessitate considerable additional quantities of UV stabilizer, with a marked detrimental effect on the economics.

Base layer and outer layer(s) may, however, comprise particles to improve the windability, provided that these particles are not whitening and at the same time incompatible (see above). Examples of such particles, organic or inorganic, are calcium carbonate, apatite, silicon dioxides, aluminium oxide, crosslinked polystyrene, crosslinked polymethyl methacrylate (PMNA), zeolites and other silicates such as aluminium silicates, or else compatible white pigments such as TiO₂ or BaSO₄. These particles are added preferably to the outer layers to improve the windability of the film. If such particles are added, preference is given to using particles based on silicon dioxide, on account of their minimal transparency-reducing effect. The fraction of these or other particles is more than 3% by weight in no layer and is preferably below 1% by weight and ideally below 0.2% by weight in every layer, based in each case on the total weight of the layer in question. These particles in the case of a multi-layer embodiment are added preferably to only one or to both outer layer(s) and enter the base layer only to a small proportion, via the regrind. In this way a minimal reduction in transparency is achieved by the particles that are required for winding. In one preferred embodiment with high windability, at least one exterior layer comprises at least 0.07% by weight of particles.

The transparency according to the invention is achieved if the raw materials and additive amounts and/or particle amounts according to the invention are used. Primarily, however, the increase in transparency is achieved through the anti-reflection coating which is present on at least one outer face of the film.

Generally speaking, particles, such as white particles or matt particles, detract from the flame properties of a biaxially oriented film. Depending on the compatibility between the particle and the polymer matrix, cavities may form around the particles during drawing. The lower the compatibility between particle and matrix, the greater the extent to which cavities develop. These cavities fill with air and in a fire scenario may feed the fire with oxygen and make the fire worse. For this reason, it usually proves advantageous in terms of combustibility to employ as few particles as possible. Exceptions are flame retardant particles of the kind described in the prior art, for instance.

For this reason, the fraction of particles, such as white (e.g. ZnO, TiO₂, BaSO₄) or matt (PMMA, SiO₂, PDMSQ) particles, is preferably below 0.5% by weight (relative to the film as a whole).

### Coating

The film of the invention bears on at least one side a coating with a material which has a lower refractive index than the polyester film. The refractive index of the film at a wavelength of 589 nm in machine direction is below 1.64, preferably below 1.60 and ideally below 1.58.

The coating of the invention comprises at least two components, namely at least one acrylic component and a component which serves for flame stabilization. The components are described below.

### Acrylic Component

Suitable acrylates are, for example, described in EP-A-0144948. Acrylate-based coatings are preferred because in a greenhouse they display no tendency for coating components to exude or for parts of the coating to flake off. Polyacrylates are particularly suitable.

Also suitable in principle for adjusting the optical properties are silicones, polyurethanes or polyvinyl acetate. It has nevertheless been shown that the fire load introduced as a result of the coating was smaller in the case of acrylates and they were better suited to stabilization.

The acrylic component according to the invention consists substantially of at least 50% by weight of one or more polymerized acrylic and/or methacrylic monomers.

The acrylic component consists preferably of an ester of acrylic or methacrylic acid, especially an alkyl ester whose alkyl group contains up to ten carbon atoms, such as the methyl, ethyl, n-propyl, isopropyl, n-butyl, isobutyl, tert-butyl, hexyl, 2-ethylhexyl, heptyl and n-octyl groups, for example. Employed with very particular preference are adhesion promoter copolymers composed of an alkyl acrylate, for example ethyl acrylate or butyl acrylate, together with an alkyl methacrylate, for example methyl methacrylate, in particular in equal molar fractions and in a total amount of 70 to 95% by weight. The acrylate comonomer in such acrylic/methacrylic combinations is present preferably in a fraction of 15 to 65 mol %, and the methacrylate comonomer is present preferably in a fraction which is generally greater by 5 to 20 mol % than the fraction of the acrylate comonomer. The methacrylate is present preferably in a fraction of 35 to 85 mol % in the combination.

In a further embodiment, the acrylic component may comprise further comonomers in a fraction of 0 to 15% by weight, these comonomers being suitable for forming an intermolecular crosslinking on exposure to elevated temperature.

Suitable comonomers with a capacity to form crosslinks are, for example, N-methylolacrylamide, N-methylolmethacrylamide, and the corresponding ethers; epoxide materials such as glycidyl acrylate, glycidyl methacrylate and allyl glycidyl ether, for example; monomers containing carboxyl groups, such as crotonic acid, itaconic acid or acrylic acid, for example; anhydrides such as maleic anhydride or itaconic anhydride, for example; monomers containing hydroxyl groups, such as allyl alcohol and hydroxyethyl or hydroxypropyl acrylate or methacrylate, for example; amides such as acrylamide, methacrylamide or maleamide, for example; and isocyanates such as vinyl isocyanate or allyl isocyanate, for example.

Of the above-stated comonomers, N-methylolacrylamide and N-methyiolmethacrylamide are preferred, the primary reason being that copolymer chains which include one of these monomers are capable of condensing with one another on exposure to elevated temperatures and hence of forming the desired intermolecular crosslinks. In the case of copolymers which include the other functional monomers, it is necessary to prepare mixtures of at least two copolymers having different functional comonomers if the desired crosslinking is to be achieved—for example, to mix an acrylic/crotonic acid copolymer with an acrylic copolymer containing isocyanate, epoxide or N-methylol functional groups which are capable of reacting with acidic functional groups.

Other specific combinations of such mixed acrylic copolymers include copolymers with monomers containing epoxide functional groups in conjunction with copolymers with monomers whose functional groups are amino, acid anhydride, carboxyl, hydroxyl or N-methylol groups; copolymers with monomers which include N-methylol or N-methylol ether groups as functional groups, in conjunction with copolymers with monomers whose functional groups are carboxyl, hydroxyl or amino groups; copolymers with monomers whose functional groups include isocyanate groups, in conjunction with copolymers with monomers whose functional groups are carboxyl or hydroxyl groups, etc. The functional monomers included in the mixed copolymer systems are present preferably in approximately equimolar amounts.

The acrylic copolymers may also be interpolymerized with up to 49% by weight of one or more halogen-free, non-acrylic, monoethylenically unsaturated monomers. Suitable comonomers are, for example, dialkyl maleates such as dioctyl maleate, diisooctyl maleate and dibutyl maleate, vinyl esters of a Versatic acid, vinyl acetate, styrene, acrylonitrile, and similar compounds.

The mixed copolymer compositions that are capable of crosslinking and are preferred for the purposes of this invention are mixtures in a ratio of approximately 50:50 (% by weight) of an ethyl acrylate/methyl methacrylate/crotonic acid copolymer with an ethyl acrylate/methyl methacrylate/glycidyl acrylate copolymer; mixtures of an ethyl acrylate/methyl methacrylate/methacrylamide copolymer with an ethyl acrylate/methyl methacrylate/N-methylolacrylamide copolymer; or compositions based on copolymers of ethyl acrylate/methyl methacrylate/N-methylolacrylamide such as, for example, copolymers which contain 50 to 99% by weight of acrylic and/or methacrylic monomers, 0 to 49% by weight of the monoethylenically unsaturated monomer and 1 to 15% by weight of N-methylolacrylamide. Particular preference is given to using copolymers which contain 70 to 95% by weight of acrylic and/or methacrylic monomers, 0 to 25% by weight of the monoethylenically unsaturated monomer and 5 to 10% by weight of N-methylolacrylamide.

As well as the acrylate component, moreover, it is possible to use an external crosslinking agent such as, for example, a melamine-formaldehyde or urea-formaldehyde condensation product. Such agents, however, should be present at not more than 3% by weight (in relation to the dried coating material) in the coating, since external crosslinking agents with a high nitrogen fraction (e.g. melamine), in particular, may give rise to a yellowing of the PET film on regrind.

In one preferred embodiment, the dried acrylate coating comprises less than 10% by weight, more preferably less than 5% by weight and ideally less than 1% by weight of repeat units which comprise an aromatic structural element. Above a proportion of 10% by weight of repeat units with an aromatic structural element, there is a marked deterioration in the weathering stability of the coating.

### Flame Stabilization Component

The coating components described and suitable for the anti-reflective (anti-glare) utility are applied at least one-sidedly and preferably double-sidedly to the surface (one-sidedly) or to the respective opposing surfaces (double-sidedly) of the single-layer or multi-layer polyester film. The coating which has been applied to one or both sides in the coat thickness range according to the invention (see below), and which is thin in relation to the thickness of the polyester film, leads already to a deterioration in the fire properties of the polyester film by comparison with the uncoated polyester film (both before and after a weathering test). In light of this result, the initial instinct is to employ flame stabilizers in order to improve the fire properties (i.e. to reduce the flammability). It has emerged, however, that the use of a flame stabilizer in the base material (that is, in the polyester of the uncoated polyester film) does not lead to any substantial improvement in the coated polyester film and hence that the desired fire behaviour is generally unachievable. Moreover, a high level of flame stabilizer in the base has adverse consequences for the transparency and especially for the haze, and so the maximum amount of flame stabilizer in the base material is limited accordingly.

Surprisingly it has been possible to show that it is sufficient to equip only the anti-reflection coating with the flame stabilizer of the invention, there being no need to equip the base material as well with a flame stabilizer in order to achieve the fire behaviour according to the invention. The additional use of a flame stabilizer in the base material, while possible in principle, does not produce any substantial improvement in the fire behaviour, and may therefore be omitted for reasons of cost-effectiveness.

A construction in which the flame stabilizer is located solely in the film, but not in the coating, which is thin by comparison with the polyester film, and which passes the fire behaviour requirements before the weathering tests, surprisingly had poorer fire properties after weathering. The adverse effect of the anti-reflection coating appears to be reinforced during weathering, as a result of exposure to water and (UV) light, with the consequence that the flame stabilization of the film is no longer able to compensate for this effect.

The construction according to the invention, in contrast, in which the coating on at least one side of the film comprises at least one flame stabilizer, was found to have sufficiently good fire properties, even after weathering, for a film with and also a film without flame stabilizer. In the fire test, after the first application of flame, such films burn up to the retaining ring in less than three out of five samples.

Added to the coating formula are one or more flame stabilizers, which improve the fire properties of the coated polyester film as a whole. Particulate compounds such as ammonium phosphates, aluminium hydroxide or magnesium hydroxide, while they do improve the flame resistance of the laminate, nevertheless have adverse effects, in the required amounts, on the optical properties. Depending on the particle size, there is an increase in the haze, and the transparency may drop. Aluminium hydroxide and magnesium hydroxide, mentioned in EP1441001, have a flame-stabilizing mechanism which involves elimination of water, and consequently they provide adequate stabilization only if added in such large quantities that the film as a whole no longer achieves the inventive optical properties. Furthermore, direct processing with polyesters made flame-stable in this way, by extrusion, proves to be difficult because of hydrolytic degradation of the polyester. If the intention was to use film offcuts and film regrind/recyclate in the production operation, moreover, any aluminium or magnesium hydroxides in the coating would impact adversely on the processing operation (especially the extrusion), since they favour the hydrolytic decomposition of the polyester, thereby lowering the viscosity of the polyester used. In one preferred embodiment, however, regrind is used, and one or both film surfaces are coated in-line with the coating of the invention in order to permit cost-effective production.

Flame stabilizers of the invention have the following structure a) and/or b):

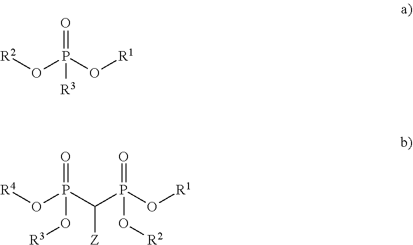

where R¹, R², R³ and R⁴ independently of one another may represent the following radical groups: H; linear alkyls with —(CH₂)ₙ—CH₃ (n=0-7); isopropyl; isobutyl or tert-butyl; linear alkyl alcohols with —(CH₂)ₙ—CH₂—OH (n=0-3), isopropyl alcohol or linear alkyl acids or alkyl acid esters with the structure —(CH₂)ₙ—COOR⁵ (with R5=H; —(CH₂)ₙ—CH₃ (n=0-3)); where at least one radical group (R¹-R⁴) does not represent H.

Z represents a radical which may be represented by the following groups: H; linear alkyls with —(CH₂)ₙ—CH₃ (n=0-10); isopropyl; isobutyl or tert-butyl; linear alkyl alcohols with —(CH₂)ₙ—CH₂—OH (n=0-5), isopropyl alcohol or linear alkyl acids or alkyl acid esters with the structure —(CH₂)ₙ—COOR⁵ (with R⁵=H; —(CH₂)ₙ—CH₃ (n=0-3)).

Particularly preferred flame stabilizers comprise compounds based on organophosphorus compounds. Phenyl-substituted phosphate compounds, such as triphenyl phosphate, bisphenol A bis(diphenylphosphate) (CAS 5945-33-5) or hexaphenoxycyclotriphosphazene oligomer (28212-48-8), have proved to be problematic in the context of processing. At the extrusion temperatures customary for PET, they may release phenol, and are therefore unsuitable.

Preference is given to oligoalkyl esters and/or alkyl esters of phosphoric acid or phosphonic acid. They dissolve in the polymer matrix of the anti-reflection coating, and differ from embedded particles in not causing any reflection or deflection of light. The refractive index of the resulting coating is within the preferred range even after addition of flame stabilizers of these kinds. Moreover, they are compatible with the production process. The refractive index n_{D} of the alkylphosphonate is preferably below 1.500, more preferably below 1.480 and very preferably below 1.4700. If the refractive index of the alkylphosphonate used is too high, there is too great a reduction in the anti-reflection effect of the coating as a whole, and the transparency is too low.

The compound in question is preferably an alkylphosphonate and/or oligo alkylphosphonate (preferably with an M_{W}≤1.000 g/mol). Under the conditions of processing, a polyalkylphosphonate does not migrate sufficiently into the polymeric constituents of the anti-reflection coating. As a consequence, the flame retardant is inadequately incorporated, can easily be rubbed off, and is therefore not available for flame retardation.

One preferred alkylphosphonate is RUCOCOAT® FR2200 from Rudolf Chemie (Geretsried, Germany).

The fraction based on phosphorus in the anti-reflection coating is between 2% and 18% by weight, preferably between 3% and 17% by weight, more preferably between 4% and 16% by weight. If the fraction of flame stabilizer relative to the anti-reflection component is below the limiting values stated above, the flame resistance requirements may not be met. If the fraction is too high, the flame stabilizer no longer dissolves completely in the polymeric anti-reflection component and may exude during production and in the subsequent utility, and/or may tend to flake off in parts.

### Other Coating Components

Additionally up to 10% by weight of additives may be added to the coating. They include surfactants (ionic, nonionic and amphoteric), protective colloids, UV stabilizers, defoamers and biocides. Especially suitable as surfactants are SDS (sodium dodecyl sulfate), polyethylene glycol-based surfactants with a C8-C20 alkyl tail (branched or unbranched) and a polar head with —(CH₂—O)ₙ—R units (where n=8-100 and R=—OH, —CH₃ or —CH₂—CH₃) such as: LUTENSOL® AT50 or TERGITOL®, for example.

In one particularly preferred embodiment the coating contains at least 1% by weight, based on the dry weight, of a UV stabilizer, preferably TINUVIN® 479 or TINUVIN® 5333-DW (BASF, Ludwigshafen, Germany). Less preferred are HALS (hindered amine light stabilizers), since on regrind (recycling of film remnants from production) they lead to a marked yellowing of the material and hence to a reduction in transparency.

### Coating Thickness

The dry thickness of the anti-reflection coating is in each case at least 60 nm, preferably at least 70 nm and more particularly at least 78 nm and is not more than 130 nm, preferably not more than 115 nm and ideally not more than 110 nm. By this means an ideal increase in transparency in the desired wavelength range is achieved. In one preferred embodiment the thickness of the coating is more than 87 nm, and more preferably more than 95 nm. In this preferred embodiment, the thickness of the coating is preferably less than 115 nm and ideally below 110 nm. Within this narrow thickness range, the increase in transparency is close to the optimum, and at the same time, in this range, the reflection of the UV and blue region of the light is increased relative to the rest of the visible spectrum. This on the one hand saves on UV stabilizer, but in particular means that the blue/red ratio shifts in favour of the red fraction. This achieves improved plant growth and increased flower initiation and fruit set, and counteracts the etiolation of the plants.

In one embodiment, the side of the film opposite the above-described anti-reflection coating likewise exhibits an anti-reflective modification. In one preferred embodiment, the coating of the composition corresponds to the opposite coating and in an especially preferred embodiment is identical in material and coating thickness to the opposite coating.

The coating or coatings are preferably applied to the film in-line prior to transverse drawing, by means of known methods (e.g. reverse gravure roll or else meyer bar) from preferably aqueous dispersion. In one embodiment the film is coated offline (e.g. by forward gravure).

To produce the anti-reflection coating, it is possible for all the components to be introduced either in dry form or neat (i.e. in an undissolved or undispersed state) and then dispersed (or dissolved) in the aqueous medium, or to each be introduced individually as a predispersion or solution in the aqueous medium, and then mixed and optionally diluted with water. Where the components are employed in each case in individually dispersed or dissolved form, it has proved to be favourable if the resulting mixture (the anti-reflection coating) is homogenized with a stirrer for at least 10 minutes before being used. If the components are employed in a pure form (i.e. in the undissolved or undispersed state), then it has proved to be particularly favourable if high shearing forces are applied at the dispersion stage, through the use of corresponding homogenization techniques.

Depending on the mode/method of application (in-line (e.g. reverse gravure, meyer bar, etc.) or off-line (e.g. forward gravure)), the non-aqueous fraction of the dispersion is preferably in the range from 5 to 35% by weight and more preferably in the range from 10 to 30% by weight.

With an anti-reflection coating applied to both sides, the transparency values of >95.3% that are particularly preferred in accordance with the invention can be achieved.

### Production Process

The polyester polymers of the individual layers are produced by polycondensation either from dicarboxylic acids and diol or else from the esters of the dicarboxylic acids, preferably the dimethyl esters, and diol. SV values of polyesters that can be used are preferably in the range from 500 to 1300, where the individual values are relatively unimportant but the average SV value of the raw materials used ought to be greater than 700 and is preferably greater than 750.

The particles, and also UV stabilizers, can be added before production of the polyester is concluded. To this end, the particles are dispersed in the diol, optionally ground, decanted or/and filtered, and added to the reactor, either in the (trans)esterification step or in the polycondensation step. In a preferred procedure a concentrated particle-containing or additive-containing polyester masterbatch can be produced by using a twin-screw extruder and diluted with particle-free polyester during film extrusion. It has been found here that masterbatches comprising less than 30% by weight of polyester are advantageously avoided. In particular, the masterbatch comprising SiO₂ particles should comprise no more than 20% by weight of SiO₂ (because of gelling risk). Another possibility is that of adding particles and additives directly during film extrusion in a twin-screw extruder.

When single-screw extruders are used, it has been found that the polyesters are advantageously predried. When a twin-screw extruder with devolatilization section is used, the drying step can be omitted.

The polyester or polyester mixture of the layer, or of the individual layers in the case of multi-layer films, is first compressed and liquefied in extruders. The melt(s) is/are then shaped in a mono- or coextrusion die to give flat melt-films, forced through a slot die and drawn off on a chill roll and on one or more take-off rolls, where the material cools and solidifies.

The film of the invention is biaxially oriented, i.e. biaxially stretched. Biaxial orientation of the film is most frequently carried out sequentially. Orientation here is preferably carried out first in longitudinal direction (i.e. in machine direction=MD) and then in transverse direction (i.e. perpendicularly to machine direction=TD). Orientation in longitudinal direction can be carried out with the aid of two rolls running at different speeds corresponding to the desired stretching ratio. The transverse orientation process generally uses an appropriate tenter frame.

The temperature at which stretching is carried out can vary within a relatively wide range, and depends on the desired properties of the film. Stretching in longitudinal direction is generally carried out in a temperature range from 80 to 130° C. (heating temperatures from 80 to 130° C.) and stretching in transverse direction is generally carried out in a temperature range from 90° C. (start of stretching) to 140° C. (end of stretching). The longitudinal stretching ratio is in the range from 2.5:1 to 4.5:1, preferably from 2.8:1 to 3.4:1. A stretching ratio above 4.5 leads to significantly reduced ease of production (break-off). The transverse stretching ratio is generally in the range from 2.5:1 to 5.0:1, preferably from 3.2:1 to 4:1. A transverse stretching ratio higher than 4.8 leads to significantly reduced ease of production (break-off) and should therefore preferably be avoided. For achievement of the desired film properties it has been found that the stretching temperature (in MD and TD) is advantageously below 125° C. and preferably below 118° C. Before transverse stretching, one or both surfaces of the film can be in-line coated by the processes known per se. In-line coating can preferably serve to apply the coating in order to increase transparency (anti-reflective). During the heat-setting that follows, the film is maintained at a temperature from 150 to 250° C. for a period of about 0.1 to 10 s under tension and, in order to achieve the preferred shrinkage values and elongation values, is relaxed in transverse direction by at least 1%, preferably at least 3% and more preferably at least 4%. This relaxation preferably takes place in a temperature range from 150 to 190° C.

In one particularly cost-effective way of producing the polyester film, the offcut material (regrind) may be supplied to the extrusion again in an amount of up to 70% by weight, based on the total weight of the film, without any notably adverse effect on the physical properties of the film.

In another embodiment the coating or coatings according to the present invention are applied to the corresponding surfaces of the polyester film by means of off-line technology in an additional operating step after film production, where a gravure roll (forward gravure) is used. The maximum limits (i.e. maximum wet add-on) are determined by the process conditions and by the viscosity of the coating dispersion, and find their upper limit in the processability of the coating dispersion.

### Applications

The films of the invention have excellent suitability as a high-transparency convection barrier, in particular for the production of energy-saving sheets in greenhouses. The film here is usually cut into narrow strips from which, in combination with polyester yarn (which ought also to be UV-resistant) a woven fabric/laid scrim is then produced which is suspended in a greenhouse. The strips made of film of the invention can be combined here with strips made of other films (in particular with films having a light-scattering effect).

Alternatively, the film itself (full area, without textile) can also be installed in a greenhouse.

### Analysis

The following test methods were used to characterize the raw materials and the films:

### UV/Vis Spectra and Transmission at Wavelength x

The films were tested in transmission in a UV/Vis double-beam spectrometer (LAMBDA® 12 or 35) from Perkin Elmer (Waltham, USA). This was done by inserting an approximately (3×5) cm-sized film specimen into the beam path, vertically with respect to the measuring beam, via a flat-sample holding device. The measuring beam leads via a 50 mm Ulbricht sphere to the detector, where the intensity is determined in order to ascertain the transparency at a desired wavelength.

Air is used as background. The transmission is read off at the desired wavelength.

### Transparency and Haze

The test is used to determine the haze and transparency of polymeric films for which optical clarity or haze is vital to the utility. The measurement is carried out on the HAZEGARD® Hazemeter XL-21 1 from BYK Gardner (Wesel, Germany) in accordance with ASTM D 1003-61.

### UV Stability

The UV stability was determined as described on page 8 of DE69731750 (DE of WO9806575,) and the UTS value was expressed as a percent of the original value, with the weathering time being 2000 rather than 1000 h.

### SV (Standard Viscosity)

The standard viscosity SV in dilute solution was measured, in a method based on DIN 53 728 Part 3, in an Ubbelohde viscometer at (25±0.05) ° C. The solvent used was dichloroacetic acid (DCA). The concentration of the dissolved polymer was 1 g of polymer/100 ml of pure solvent. The polymer was dissolved at 60° C. for 1 hour. If the samples were not fully dissolved after this time, up to two more dissolution attempts were made, at 80° C. for 40 minutes in each case, after which the solutions were centrifuged for 1 hour at a speed of 4100 min−1.

The dimensionless value SV is determined from the relative viscosity (ηᵣₑₗ−η/ηₛ) as follows:

SV=(ηᵣₑₗ−1)×1000

The fraction of particles in the film or raw polymer material was determined by ashing and corrected by an appropriate increase in the input weight, i.e.:

$$Input weight = \frac{( Input weight corresponding to 100 \% polymer )}{[ ( 100 - Particle content in \% by weight ) \cdot 0.01 ]}$$

### Determination of Film and Coating Refractive Index as a Function of Wavelength

The refractive index of a film substrate and of an applied coating was determined as a function of wavelength by spectroscopic ellipsometry.

To this end, the base film without coating is first analysed. Reverse-side reflection is suppressed by using an abrasive paper of the finest possible grade (for example P1000) to roughen the reverse side of the film. The film is then subjected to measurement by a spectroscopic ellipsometer, for example an M-2000 from J. A. Woollam Co., Inc., equipped with a rotating compensator. The machine direction (MD) of the sample is parallel to the light beam. The wavelength used for measurement is in the range from 370 to 1000 nm; the measurement angles are 65, 70 and 75°.

A model is then used to simulate the ellipsometric data Ψ and Δ. The Cauchy model

$$n ( λ ) = A + \frac{B}{{λ}^{2}} + \frac{C}{{λ}^{4}}$$

(wavelength λ in μm) is suitable for this purpose in the present case. The parameters A, B and C are varied in such a way that the data provide the best possible fit with Ψ and Δ in the measured spectrum. The validity of the model can be checked by using the MSE value, which compares model with measured data (Ψ(λ) and Δ(λ)) and should be as small as possible.

$$MSE = \sqrt{\frac{1}{3 n - m} {\sum }_{i = 1}^{n} [ {( {N}_{E , i} - {N}_{G , i} )}^{2} + {( {C}_{E , i} - {C}_{G , i} )}^{2} + {( {S}_{E , i} - {S}_{G , i} )}^{2} ]} \cdot 1000$$

n number of wavelengths, m=number of fit parameters, N=cos(2Ψ), C=sin(2Ψ) cos(Δ), S=sin(2Ψ) sin(Δ) [1][1] J. A. Woollam et al, Overview of variable-angle spectroscopic ellipsometry (VASE): I. Basic theory and typical applications, Proc. SPIE Vol. CR72, pp. 3-28, Optical Metrology, Ghanim A. Al-Jumaily; Ed.

The Cauchy parameters A, B and C obtained for the base film allow calculation of the refractive index n as a function of wavelength, with validity in the range of measurement from 370 to 1000 nm.

The coating, or a modified coextruded layer, can be analysed analogously. The parameters of the film base are now already known, and should be kept constant in the modelling procedure. Determination of the coating of the coextruded layer also requires roughening of the reverse side of the film, as described above. The Cauchy model can likewise be used here to describe the refractive index as a function of the wavelength. However, the respective layer is now present on the already known substrate, and this is taken into account in the respective evaluation software (CompleteEASE or WVase). The thickness of the layer influences the spectrum obtained, and must be taken into account in the modelling procedure.

### Determination of the Refractive Index n_{D} of a Liquid

The refractive index is determined using the Abbe refractometer.

Care must be taken to ensure that the temperature of the Abbe refractometer is 23° C. Using a pipette, the liquid for analysis is applied to the lower prism, which has been cleaned thoroughly before the test, so that the entire prism surface is covered. The second prism is swung down and pressed on firmly. Subsequently, using the corresponding knurled screw, the indicator scale is turned until a transition from light to dark can be seen in the viewing window. If the transition from light to dark is not sharply defined, the corresponding knurled screw is used to bring the colours together so that only one light and one dark zone are visible. The sharp transition line is brought to the point of intersection of the two diagonal lines (in the eyepiece) using the corresponding knurled screw. The value displayed on the measuring scale at this point is read off and entered into the test records.

### Fire Behaviour

Fire testing takes place as described in EN ISO 9773:1998/A1:2003. The specimens are conditioned beforehand only at (23±2) ° C. and a relative humidity of (50±5) % (for one day). In the present case, the testing point of whether the film specimen burns to the 125 mm mark described in the standard is particularly important. During testing, moreover, a note is made of whether the 125 mm mark is reached after the first or second application of flame, or not at all.

### EXAMPLES

The inventive examples (according to the invention) employ the following raw materials:
PET1=Polyethylene terephthalate raw material made from ethylene glycol and terephthalic acid, with an SV of 820 and DEG content of 0.9% by weight (diethylene glycol content as monomer).
PET2=Polyethylene terephthalate raw material with an SV of 730, comprising bis(2-hydroxyethyl) (6-oxodibenzo[c,e]-[1,2]-oxaphosphorin-6-ylmethyl)succinate as comonomer (the compound is a flame stabilizer typically added in masterbatch form to the extrusion; cf. EP1368405, whose United States equivalent is US 2004/0097621), the fraction of phosphorus from this comonomer being 18 000 ppm in the raw material.
PET3=Polyethylene terephthalate raw material made from ethylene glycol and dimethyl terephthalate, with an SV of 820 and DEG content of 0.9% by weight (diethylene glycol content as monomer) and 1.5% by weight of SYLOBLOC® 46 silicon dioxide pigment with a d₅₀ of 2.5 μm. Produced by PTA process. Catalyst potassium titanyloxalate with 18 ppm of titanium. Transesterification catalyst zinc acetate.
PET4=Polyethylene terephthalate raw material with an SV of 700, containing 20% by weight of TINUVIN® 1577 UV stabilizer. The composition of the UV stabilizer is as follows: 2-(4,6-diphenyl-1,3,5-triazin-2-yl)-5-(hexyl)oxyphenol (TINUVIN® 1577 from BASF, Ludwigshafen, Germany). TINUVIN® 1577 has a melting point of 149° C. and is thermally stable at 330° C.

### Inventive Example 1

Outer layers (A) and (A′): Mixture of
10% by weight PET4
7.2% by weight PET3
82.8% by weight PET1

Base layer (B): Mixture of
90% by weight PET1
10% by weight PET4
   Coating, on each of outer layers (A) and (A′):

Stir 13% by weight of alkylphosphonate (RUCO-COAT FR2200, Rudolf Chemie, Geretsried, Germany) as flame stabilizer into water, adjust pH to 7.5 to 8.0 using aqueous ammonia, and, with stirring, add 10% by weight of acrylate (as an aqueous dispersion, EP-A-0144948 (whose United States equivalent is U.S. Pat. No. 4,571,363, hereby incorporated by reference herein), Example 1 with the surfactant SDS and TERGITOL® 15-S-40).

The raw materials listed were melted in one extruder per layer at 292° C. and extruded through a three-layer slot die onto a take-off roll cooled to 50° C. The amorphous preliminary film thus obtained was then subjected initially to longitudinal stretching. The longitudinally stretched film was corona-treated in a corona discharge apparatus, and then coated by reverse gravure coating with the coating formula described. The coating was transferred analogously to the previously uncoated surface in a second reverse gravure coating operation. Thereafter the film was dried at a temperature of 100° C. and subsequently subjected to transverse stretching, setting, and winding (final film thickness 19.0 μm, outer layers each 1.0 μm). The conditions in the individual steps of the process were as follows:

TABLE 1
Operating parameters of boPET production
for inventive example 1.

| | | | |
|---|---|---|---|
| Longitudinal | Heating temperature | 75-115 | ° C. |
| stretching | Stretching temperature | 115 | ° C. |
| | Longitudinal stretching | 3.8 | |
| | ratio | | |
| Transverse | Heating temperature | 100 | ° C. |
| stretching | Stretching temperature | 112 | ° C. |
| | Transverse stretching ratio | 3.9 | |
| | (including stretching in 1st | | |
| | setting field) | | |
| Setting | Temperature | 237-150 | ° C. |
| | Time | 3 | s |
| | Relaxation in TD at 200- | 5 | % |
| | 150° C. | | |
| Setting | Temperature of 1st setting | 170 | ° C. |
| | field | | |

The thickness of the dry coating on either side is 80 nm in each case.

The properties of the resulting film are set out in Table 3.

### Inventive Examples 2 to 4 and Comparative Examples 1 to 10

The rest of the examples are based on the production procedure in analogy to inventive example 1. The formulas for the base film and for the coating are described in Table 2 below.

The coating from comparative example 4 consists of 7.5% by weight of NEOREZ® R600 polyurethane from DSM and 7.5% by weight of EPOCROS® WS-700 oxazoline crosslinker from Sumitomo.

The coating from comparative example 5 consists of a silicone batch as described in Example 1 of EP-A-0769540 (whose United States equivalent is U.S. Pat. No. 5,672,428, which is hereby incorporated by reference herein).

The coatings from comparative examples 6 and 7 consist in each case of a mixture of the acrylate (EP-A-0144948) and an ammonium phosphate (EXOLIT® AP420 from Clariant, 45% by weight aqueous dispersion).

TABLE 2
Overview of formulas for inventive and comparative examples

| | Inv. | Inv. | Inv. | Inv. | Comp. | Comp. | Comp. | Comp. |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| Film formula | | | | | | | | |
| Coex A | 1 μm | 1 μm | 1 μm | 1 μm | 1 μm | 1 μm | 1 μm | 1 μm |
| PET4 | 10.0 | 10.0 | 10.0 | 10.0 | 10.0 | 10.0 | 10.0 | 10.0 |
| PET3 | 7.2 | 7.2 | 7.2 | 7.2 | 7.2 | 7.2 | 7.2 | 7.2 |
| PET1 | 82.8 | 82.8 | 82.8 | 82.8 | 82.8 | 82.8 | 82.8 | 82.8 |
| PET2 | | | | | | | | |
| Base | 17 μm | 17 μm | 17 μm | 17 μm | 17 μm | 17 μm | 17 μm | 17 μm |
| PET4 | 10.0 | 10.0 | 10.0 | 10.0 | 10.0 | 10.0 | 10.0 | 10.0 |
| PET2 | | | | | | | | |
| PET1 | 90.0 | 90.0 | 90.0 | 90.0 | 90.0 | 90.0 | 90.0 | 90.0 |
| Coex A′ | 1 μm | 1 μm | 1 μm | 1 μm | 1 μm | 1 μm | 1 μm | 1 μm |
| PET4 | 10.0 | 10.0 | 10.0 | 10.0 | 10.0 | 10.0 | 10.0 | 10.0 |
| PET3 | 7.2 | 7.2 | 7.2 | 7.2 | 7.2 | 7.2 | 7.2 | 7.2 |
| PET1 | 82.8 | 82.8 | 82.8 | 82.8 | 82.8 | 82.8 | 82.8 | 82.8 |
| PET2 | | | | | | | | |
| Coating formula | | | | | | | | |
| | both | both | both | one | un- | one | both | both |
| | sides | sides | sides | side | coated | side | sides | sides |
| | on A&A′ | on A&A′ | on A&A′ | on A | | on A | on A&A′ | on A&A′ |
| Acrylate | 10 | 5 | 15 | 10 | | 15 | 15 | |
| Alkylphosphonate | 13 | 25 | 5 | 15 | | | | |
| Ammonium | | | | | | | | |
| phosphate | | | | | | | | |
| Polyurethane | | | | | | | | 7.5 |
| Oxazoline | | | | | | | | 7.5 |
| crosslinker | | | | | | | | |
| Silicone | | | | | | | | |
| batch | | | | | | | | |
| EP-A-0769540 | | | | | | | | |
| Fraction of | 10.7% | 15.8% | 4.8% | 11.4% | | | | |
| phosphorus in | | | | | | | | |
| anti-reflection | | | | | | | | |
| coating | | | | | | | | |
| Dry thickness | 80 | 80 | 105 | 80 | 0 | 80 | 80 | 80 |
| [nm] | | | | | | | | |
| (per side, | | | | | | | | |
| if double-sidedly | | | | | | | | |
| coated) | | | | | | | | |

| | Comp. | Comp. | Comp. | Comp. | Comp. | Comp. |
|---|---|---|---|---|---|---|
| | Ex. 5 | Ex. 6 | Ex. 7 | Ex. 8 | Ex. 9 | Ex. 10 |
| Film formula | | | | | | |
| Coex A | 1 μm | 1 μm | 1 μm | 1 μm | 1 μm | 1 μm |
| PET4 | 10 | 10.0 | 10.0 | 10.0 | 10.0 | 10.0 |
| PET3 | 7.2 | 7.2 | 7.2 | 7.2 | 7.2 | 7.2 |
| PET1 | 82.8 | 82.8 | 82.8 | 74.8 | 74.8 | 74.8 |
| PET2 | | | | 8.0 | 8.0 | 8.0 |
| Base | 17 μm | 17 μm | 17 μm | 17 μm | 17 μm | 17 μm |
| PET4 | 10 | 10.0 | 10.0 | 10.0 | 10.0 | 10.0 |
| PET2 | | | | 8.0 | 8.0 | |
| PET1 | 90 | 90.0 | 90.0 | 82.0 | 82.0 | 90.0 |
| Coex A′ | 1 μm | 1 μm | 1 μm | 1 μm | 1 μm | 1 μm |
| PET4 | 10 | 10.0 | 10.0 | 10.0 | 10.0 | 10.0 |
| PET3 | 7.2 | 7.2 | 7.2 | 7.2 | 7.2 | 7.2 |
| PET1 | 82.8 | 82.8 | 82.8 | 74.8 | 74.8 | 74.8 |
| PET2 | | | | 8.0 | 8.0 | 8.0 |
| Coating formula | | | | | | |
| | one | both | both | un- | both | both |
| | side | sides | sides | coated | sides | sides |
| | on A | on A&A′ | on A&A′ | | on A&A′ | on A&A′ |
| Acrylate | | 13 | 10 | | 15 | 15 |
| Alkylphosphonate | | | | | | |
| Ammonium | | 2 | 5 | | | |
| phosphate | | | | | | |
| Polyurethane | | | | | | |
| Oxazoline | | | | | | |
| crosslinker | | | | | | |
| Silicone | 14 | | | | | |
| batch | | | | | | |
| EP-A-0769540 | | | | | | |
| Fraction of | | | | | | |
| phosphorus in | | | | | | |
| anti-reflection | | | | | | |
| coating | | | | | | |
| Dry thickness | 105 | 80 | 80 | 0 | 60 | 60 |
| [nm] | | | | | | |
| (per side, | | | | | | |
| if double-sidedly | | | | | | |
| coated) | | | | | | |

TABLE 3
Properties of inventive and comparative examples

| | Inv. | Inv. | Inv. | Inv. | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| Refractive | 1.503 | 1.483 | 1.522 | 1.523 | −/− | 1.508 | 1.508 |
| index of | | | | | | | |
| coating, nD, | | | | | | | |
| 589 nm in MD | | | | | | | |
| Transparency | 96.5 | 95.6 | 96.4 | 93.5 | 90.4 | 93.3 | 96.2 |
| [%] | | | | | | | |
| Haze [%] | 3.94 | 4.01 | 3.53 | 2.00 | 3.87 | 4.66 | 5.72 |
| Fire test | | | | | | | |
| Burned down | 5 | 4 | 5 | 5 | 3 | 5 | 5 |
| to holder | | | | | | | |
| after 1st and | | | | | | | |
| 2nd flame | | | | | | | |
| application | | | | | | | |
| Burned down | 0 | 0 | 2 | 2 | 0 | 3 | 4 |
| to holder | | | | | | | |
| after 1st | | | | | | | |
| flame | | | | | | | |
| application | | | | | | | |
| Fire test | | | | | | | |
| after | | | | | | | |
| weathering | | | | | | | |
| Burned down | 5 | 5 | 5 | 5 | 4 | 5 | 5 |
| to holder | | | | | | | |
| after 1st and | | | | | | | |
| 2nd flame | | | | | | | |
| application | | | | | | | |
| Burned down | 1 | 0 | 2 | 3 | 1 | 2 | 5 |
| to holder | | | | | | | |
| after 1st | | | | | | | |
| flame | | | | | | | |
| application | | | | | | | |

| | Comp. | Comp. | Comp. | Comp. | Comp. | Comp. | Comp. |
|---|---|---|---|---|---|---|---|
| | Ex. 4 | Ex. 5 | Ex. 6 | Ex. 7 | Ex. 8 | Ex. 9 | Ex. 10 |
| Refractive | 1.475 | 1.410 | 1.510 | 1.509 | −/− | 1.508 | 1.508 |
| index of | | | | | | | |
| coating, nD, | | | | | | | |
| 589 nm in MD | | | | | | | |
| Transparency | 95.3 | 94.4 | 95.6 | 94.1 | 90.8 | 94.8 | 94.7 |
| [%] | | | | | | | |
| Haze [%] | 7.09 | 2.4 | 8.54 | 27.1 | 2.3 | 3.5 | 3.5 |
| Fire test | | | | | | | |
| Burned down | 4 | 5 | 5 | 4 | 5 | 5 | 5 |
| to holder | | | | | | | |
| after 1st and | | | | | | | |
| 2nd flame | | | | | | | |
| application | | | | | | | |
| Burned down | 4 | 5 | 2 | 2 | 0 | 2 | 3 |
| to holder | | | | | | | |
| after 1st | | | | | | | |
| flame | | | | | | | |
| application | | | | | | | |
| Fire test | | | | | | | |
| after | | | | | | | |
| weathering | | | | | | | |
| Burned down | 5 | 5 | | | | 5 | 5 |
| to holder | | | | | | | |
| after 1st and | | | | | | | |
| 2nd flame | | | | | | | |
| application | | | | | | | |
| Burned down | 5 | 5 | | | | 4 | 4 |
| to holder | | | | | | | |
| after 1st | | | | | | | |
| flame | | | | | | | |
| application | | | | | | | |

That which is claimed:

1. A single-layer or multi-layer, biaxially oriented polyester film bearing on at least one film surface a coating for transparency increase, wherein:
the polyester film has a particle fraction of not more than 0.5% by weight, and
the coating represents the product of drying of a water-based or solvent-based solution and/or dispersion, where
(i) the coating has a dry coat thickness of 60-130 nm,
(ii) the coating for transparency increase comprises at least one acrylic acid-based and/or methacrylic acid-based polymer and
(iii) comprises as flame stabilizer at least one alkylphosphonate and/or oligo-alkyiphosphonate, where
(iv) the coating has a refractive index n<1.64 and
(v) the phosphorus fraction of the coating is between 2 and 18% by weight.

2. The polyester film according to claim 1, wherein:
the film has a minimum transparency of 93.5%,
a maximum haze of 8%,
a flame retardancy wherein the number of samples in a fire test which burn up to the retaining ring after the first flame application is less than 3 out of 5, both before and after weathering.

3. The polyester film according to claim 1, wherein the film has a transmission in the wavelength range from below 370 nm to 300 nm that is less than 40% at every wavelength in said range.

4. The polyester film according to claim 1, wherein the coating comprises for transparency increase a material which has a lower refractive index than the polyester film.

5. The polyester film according to claim 4, wherein the refractive index of the material for transparency increase in the coating is below 1.64 in the machine direction of the film at a wavelength of 589 nm.

6. Polyester film according to claim 4, wherein the coating comprises for transparency increase a flame stabilizer having the following structure a) and/or b): 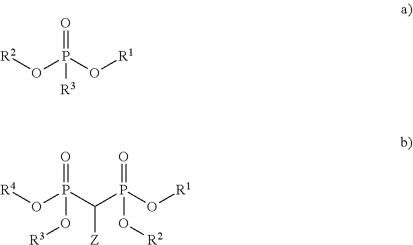
where
R¹, R², R³ and R⁴ independently of one another represent the following radical groups:
H; linear alkyls with —(CH₂)ₙ—CH₃ (n=0-7); isopropyl; isobutyl or tert-butyl; linear alkyl alcohols with —(CH₂)ₙ—CH₂—OH (n=0-3), isopropyl alcohol or linear alkyl acids or alkyl acid esters with the structure —(CH₂)ₙ—COOR⁵ (with R5=H; —(CH₂)ₙ—CH; (n=0-3)); where at least one radical group R¹-R⁴ does not represent H;
Z represents a radical which is represented by the following groups:
H; linear alkyls with —(CH₂)ₙ—CH₃ (n=0-10); isopropyl; isobutyl or tert-butyl; linear alkyl alcohols with —(CH₂)ₙ—CH₂—OH (n=0-5), isopropyl alcohol or linear alkyl acids or alkyl acid esters with the structure —(CH₂)ₙ—COOR⁵ (with R⁵=H; —(CH₂)ₙ—CH₃ (n=0-3)).

7. Polyester film according to claim 6, wherein the flame stabilizer is an oligoester and/or alkyl ester of phosphoric acid or phosphonic acid.

8. The polyester film according to claim 1, wherein the coating comprises at least two components:
an acrylic component and
a component serving for flame stabilization.

9. The polyester film according to claim 8, wherein the acrylic component consists of at least 50% by weight of one or more polymerized acrylic and/or methacrylic monomers.

10. The polyester film according to claim 8, wherein the acrylic component consists of an ester of acrylic or methacrylic acid.

11. The polyester film according to claim 10, wherein the acrylic component is an alkyl ester whose alkyl group contains up to 10 carbon atoms.

12. The polyester film according to claim 8, wherein the acrylic component consists of an alkyl acrylate together with an alkyl methacrylate.

13. Polyester film according to claim 8, wherein the acrylic component comprises further comonomers in a fraction of 0 to 15% by weight which form an intermolecular crosslinking on exposure to elevated temperature.

14. Polyester film according to claim 8, wherein the acrylic component of the coating comprises less than 10% by weight of repeat units which comprise an aromatic structural element upon drying.

15. A method for producing the polyester film according to claim 1, comprising
compressing and liquifying the polyester or polyester mixture of the film layer or, in the case of multi-layer films, of the individual layers in one or more extruders to form a melt/melts an
shaping the resultant melt/melts is/are into flat melt-films in a single-phase or multi-phase die, which are then pressed through a slot die and
taking the melt-film off on a chill roll and one or more take-off rolls to form a prefilm,
cooling and solidifying the prefilm
biaxially orienting the prefilm via biaxially drawing, heat-setting and winding up the heat-set film,
wherein the process further comprises coating the film on one or both sides during biaxial orientation, with a coating for transparency increase,
wherein the coating for transparency increase is a water-based or solvent-based solution and/or dispersion that comprises at least one acrylic acid-based and/or methacrylic acid-based polymer and as flame stabilizer comprises at least one alkylphosphonate and/or oligo-alkylphosphonate, where the coating has a refractive index n<1.64 and the phosphorus fraction of the coating is between 2 and 18% by weight.

16. A high-transparency convection barrier comprising the polyester film according to claim 1.

17. The high-transparency convection barrier according to claim 16, wherein the convection barrier is an energy saving greenhouse sheet.
